(19) United States
(12) Patent Application Publication
(10) Pub. No.: US 2012/0093358 A1
(43) Pub. Date: Apr. 19, 2012

(54) CONTROL OF REAR-VIEW AND SIDE-VIEW MIRRORS AND CAMERA-COORDINATED DISPLAYS VIA EYE GAZE

(75) Inventor: Michael Dean Tschirhart, Ann Arbor, MI (US)

(73) Assignee: VISTEON GLOBAL TECHNOLOGIES, INC., Van Buren Twp., MI (US)

(21) Appl. No.: 12/905,307

(22) Filed: Oct. 15, 2010

(51) Int. Cl. G06K 9/00

(52) U.S. Cl. 382/103

(57) ABSTRACT

An adaptive vision system includes a vision component to present an image to a user, a sensor for detecting a vision characteristic of the user and generating a sensor signal representing the vision characteristic of the user; and a processor in communication with the sensor and the vision component, wherein the processor receives the sensor signal, analyzes the sensor signal based upon an instruction set to determine the vision characteristic of the user, and configures the visual component based upon the vision characteristic of the user to modify the image presented to the user.

### FIELD OF THE INVENTION

The present invention relates generally to a reconfigurable vision aide. In particular, the invention is directed to an adaptive vision system and a method for configuring the vision system based on a tracking of a user.

### BACKGROUND OF THE INVENTION

Eye-tracking devices detect the position and movement of an eye. Several varieties of eye-tracking devices are disclosed in U.S. Pat. Nos. 2,288,430; 2,445,787; 3,462,604; 3,514,193; 3,534,273; 3,583,794; 3,806,725; 3,864,030; 3,992,087; 4,003,642; 4,034,401; 4,075,657; 4,102,564; 4,145,122; 4,169,663; and 4,303,394.

Currently, eye tracking devices and methods are implemented in vehicles to detect drowsiness and erratic behavior in a driver of a vehicle, as well as enable hands-free control of certain vehicle systems.

However, drivers are frequently required to make use of vision components (e.g. mirrors or camera supported displays) to obtain visual information about the vehicle environment to conduct a range of critical tasks (lane keeping, passing, parking, etc.). The limited coverage of the mirrors and displays generally requires adjustability, typically achieved through manual control of some kind.

It would be desirable to develop an adaptive vision system wherein a vision component is automatically configured based upon a vision characteristic of a user to maximize a viewable coverage area of a vision component without the requirement of manual manipulation.

### SUMMARY OF THE INVENTION

Concordant and consistent with the present invention, an adaptive vision system wherein a vision component is automatically configured based upon a vision characteristic of a user, has surprisingly been discovered.

In one embodiment, an adaptive vision system comprises: a vision component to present an image to a user; a sensor for detecting a vision characteristic of the user and generating a sensor signal representing the vision characteristic of the user; and a processor in communication with the sensor and the vision component, wherein the processor receives the sensor signal, analyzes the sensor signal based upon an instruction set to determine the vision characteristic of the user, and configures the visual component based upon the vision characteristic of the user to modify the image presented to the user.

In another embodiment, an adaptive vision system for a vehicle comprises: a vision component configured to present an image to a user; a controller in mechanical communication with the vision component to modify a configuration of the vision component; a sensor for detecting a vision characteristic of the user and generating a sensor signal representing the vision characteristic of the user; and a processor in communication with the sensor and the controller, wherein the processor receives the sensor signal, analyzes the sensor signal based upon an instruction set to determine the vision characteristic of the user, and transmits a control signal to the controller to modify the configuration of the visual component based upon the vision characteristic of the user and thereby modify the image presented to the user.

The invention also provides methods for configuring a vision component.

One method comprises the steps of: providing the vision component configured to present an image to a user; providing a sensor to detect a vision characteristic of a user; and configuring the vision component based upon the vision characteristic of the user to modify the image presented to the user.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary perspective view of a vehicle including an adaptive vision system according to an embodiment of the present invention;

FIG. 2 is a schematic block diagram of the vision system of FIG. 1; and

FIGS. 3-5 are enlarged fragmentary front perspective views of a vision component of the vision system of FIG. 1 depicted in circles 3, 4, and 5;

FIG. 6 is an enlarged front elevational view of a vision component of the vision system of FIG. 1 depicted in circle 6; and

FIG. 7 is an enlarged front elevational view of a vision component of the vision system of FIG. 1 depicted in circle 7.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

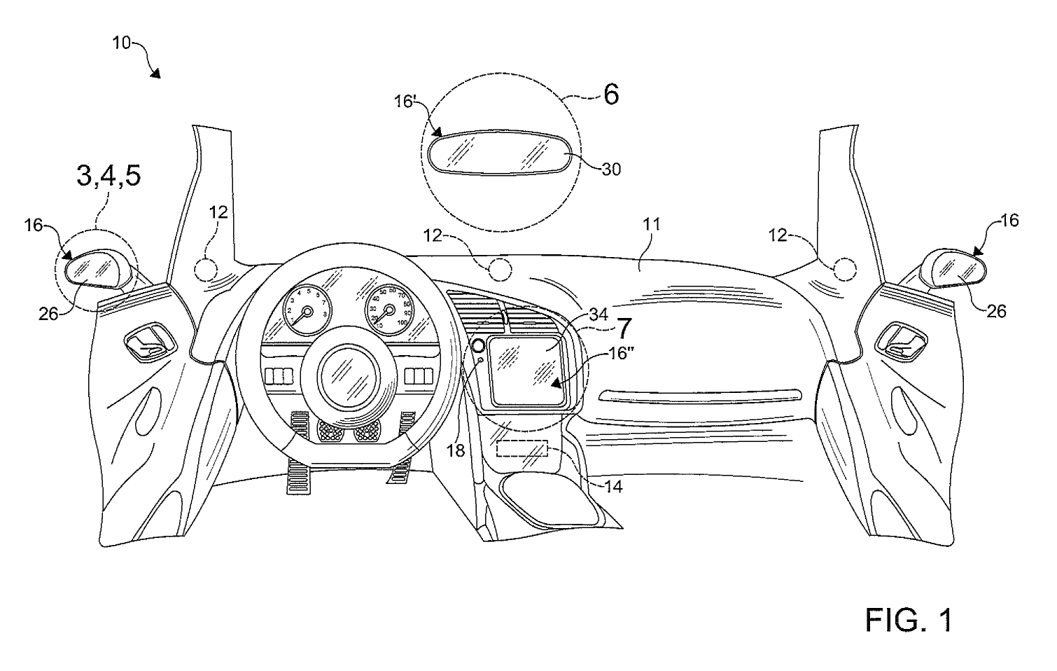

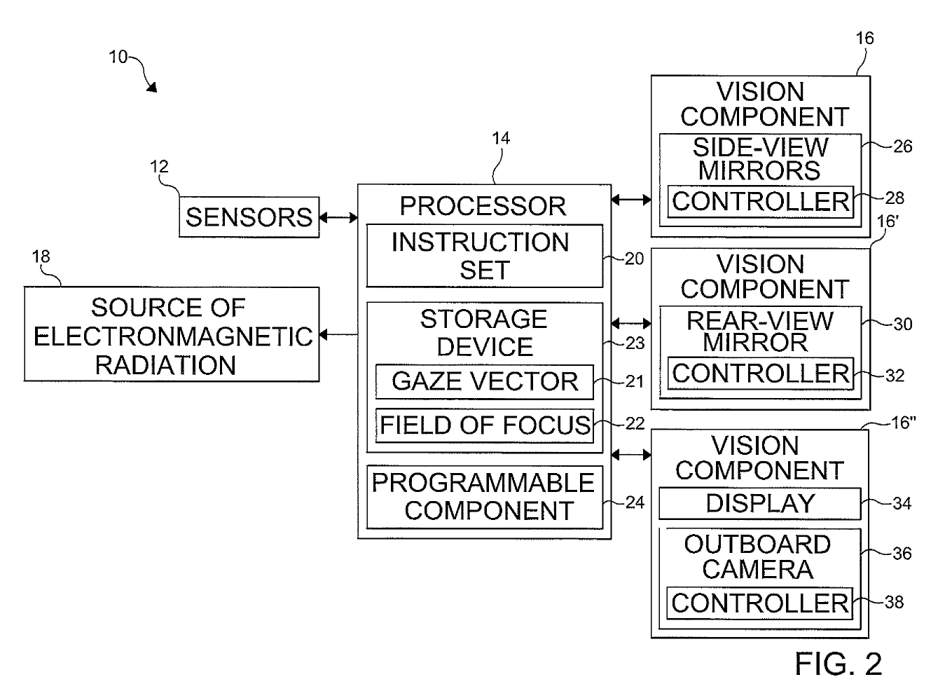

FIGS. 1-2 illustrate an adaptive vision system 10 for a vehicle 11 according to an embodiment of the present invention. As shown, the vision system 10 includes at least one sensor 12, a processor 14, and a plurality of adaptive vision components 16, 16′, 16″. The vision system 10 can include any number of components and sub-components, as desired. The vision system 10 can be integrated in any user environment.

The at least one sensor 12 is a user tracking device capable of detecting a vision characteristic of a face or head of a user (e.g. a head pose, a gaze vector or direction, a facial feature, and the like.). In certain embodiments, the at least one sensor 12 is a complementary metal-oxide-semiconductor (CMOS) camera for capturing an image of at least a portion of a head (e.g. face or eyes) of the user and generating a sensor signal representing the image. However, other cameras, image capturing devices, and the like can be used.

In the embodiment shown, a plurality of the sensors 12 is disposed along a common axis (not shown) to enable an accurate detection of a vision characteristic of the user from multiple viewing angles. However, it is understood that the sensor(s) 12 can be positioned in any location and configuration.

As a non-limiting example, a source of radiant energy 18 is disposed to illuminate at least a portion of a head of the user. As a further non-limiting example, the source of radiant energy 18 may be an infra-red light emitting diode. However, other sources of the radiant energy can be used.

The processor 14 may be any device or system adapted to receive an input signal (e.g. the sensor signal), analyze the input signal, and configure at least one of the vision components 16, 16′, 16″ in response to the analysis of the input signal. In certain embodiments, the processor 14 is a micro-computer. In the embodiment shown, the processor 14 receives the input signal from at least one of the sensor 12.

As shown, the processor 14 analyzes the input signal based upon an instruction set 20. The instruction set 20, which may be embodied within any computer readable medium, includes processor executable instructions for configuring the processor 14 to perform a variety of tasks. The processor 14 may execute a variety functions such as controlling the operation of the sensor 12 and the user interface 16, for example. It is understood that various algorithms and software can be used to analyze an image of a head, a face, or an eye of a user to determine the vision characteristics thereof (e.g. the “Smart Eye” software produced by Smart Eye AB in Sweden). It is further understood that any software or algorithm can be used to detect the vision characteristics of the head/face of the user such as the techniques described in U.S. Pat. Nos. 4,648,052, 4,720,189, 4,836,670, 4,950,069, 5,008,946 and 5,305,012, for example.

As a non-limiting example, the instruction set 20 is a software adapted to determine a gaze vector 21 of a user based upon the information received by the processor 14 (e.g. via the sensor signal). As a further non-limiting example, the processor 14 determines a field of focus 22 of at least one of the eyes of a user, wherein a field of focus 22 is a pre-determined portion of a complete field of view of the user. In certain embodiments, the field of focus 22 is defined by a pre-determined range of degrees (e.g. +/− five degrees) from the gaze vector 21 calculated in response to the instruction set 20. It is understood that any range degrees relative to the calculated gaze vector 21 can be used to define the field of focus 22. It is further understood that other vision characteristics can be determined such as head pose, for example.

In certain embodiments, the processor 14 includes a storage device 23. The storage device 23 may be a single storage device or may be multiple storage devices. Furthermore, the storage device 23 may be a solid state storage system, a magnetic storage system, an optical storage system or any other suitable storage system or device. It is understood that the storage device 23 may be adapted to store the instruction set 20. Other data and information may be stored and cataloged in the storage device 23 such as the data collected by the sensor 12, the calculated gaze vector 21, and the field of focus 22, for example.

The processor 14 may further include a programmable component 24. It is understood that the programmable component 24 may be in communication with any other component of the vision system 10 such as the sensor 12 and the user interface 16, for example. In certain embodiments, the programmable component 24 is adapted to manage and control processing functions of the processor 14. Specifically, the programmable component 24 is adapted to modify the instruction set 20 and control the analysis of the signals and information received by the processor 14. It is understood that the programmable component 24 may be adapted to manage and control the sensor 12 and at least one of the vision components 16, 16′, 16″. It is further understood that the programmable component 24 may be adapted to store data and information on the storage device 23, and retrieve data and information from the storage device 23.

The vision component 16 includes a pair of side-view mirrors 26 for presenting (e.g. reflecting) an image to the user. It is understood that any number of the side-view mirrors 26 can be used, including one. It is further understood that any type of side-view mirror 26 can be used. As a non-limiting example, each of the side-view mirrors 26 includes a controller 28 (e.g. motor) for positioning and configuring the respective one of the side-view mirrors 26 to modify the image presented by the respective one of the side-view mirrors 26 with respect to the user.

The vision component 16′ includes a rear-view mirror 30 for presenting (e.g. reflecting) a visible image to the user. It is understood that any number of the rear-view mirrors 30 can be used, including one. It is further understood that any type of rear-view mirror 30 can be used. As a non-limiting example, the rear-view mirror 30 includes a controller 32 (e.g. motor) for positioning and configuring the rear-view mirror 30 to modify the image presented by the rear-view mirror 30 with respect to the user.

The vision component 16″ includes a display 34. The display 34 is configured to generate a visual output to the user based upon an image captured by an outboard camera 36. As a non-limiting example, the outboard camera 36 is disposed to view an area to a rear of the vehicle 11. However, it is understood that the display 34 can be configured to generate the visual output based upon any source, from any location and field of view. As a non-limiting example, the outboard camera 36 of the vision component 16″ includes a controller 38 for adjusting a field of view of the camera 36 to modify the image presented on the display 34.

In operation, the user interacts with the vision components 16, 16′, 16″ of the vision system 10 in a conventional manner. The processor 14 continuously receives the input signals (e.g. sensor signal) and information relating to the vision characteristics of the user. The processor 14 analyzes the input signal and the information based upon the instruction set 20 to determine the vision characteristics of the user. At least one of the vision components 16, 16′, 16″ is automatically configured by the processor 14 based upon the vision characteristics of the user. As a non-limiting example, the processor 14 transmits a control signal to at least one of the controllers 28, 30 to modify a position of a respective one of the vision components 16, 16′ based upon the vision characteristic of the user. As a further non-limiting example, the processor 14 transmits a control signal to the controller 38 to configure the outboard camera 36 in response to the detected vision characteristics of the user, thereby modifying the visible output presented on the display 34.

It is understood that the user can manually modify the configuration of the vision components 16, 16′, 16″. It is further understood that the user interface 16 may provide a selective control over the automatic configuration of the vision components 16, 16′, 16″. For example, the vision components 16, 16′, 16″ may always revert to a default configuration unless the user initiates a vision mode, wherein at least one of the vision components 16, 16′, 16″ is automatically configured to the personalized configuration associated with the vision characteristics of the user.

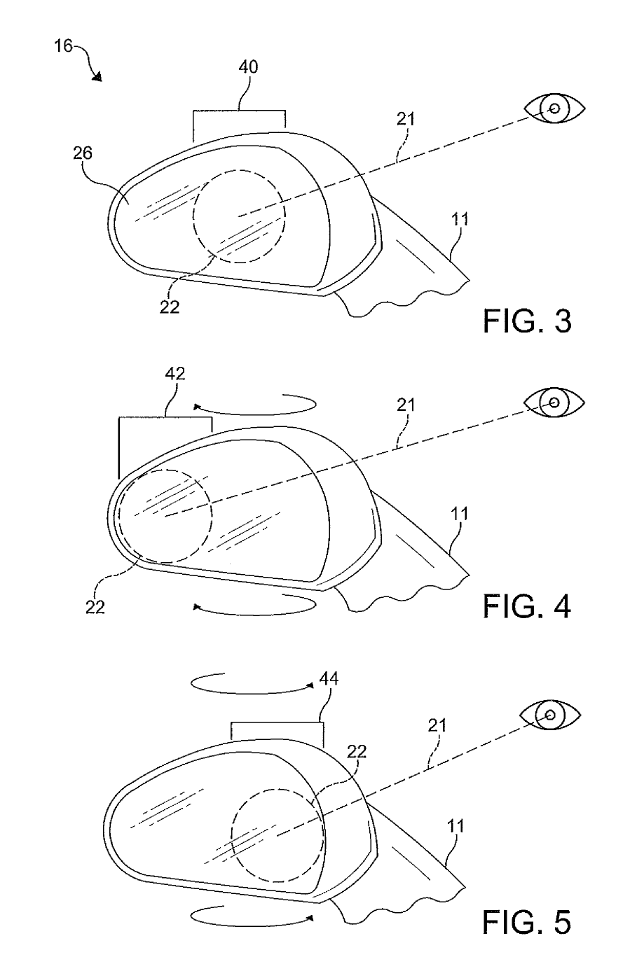

An example of a personalized configuration is shown in FIGS. 3-5. As shown in FIG. 3, the user is gazing toward a pre-defined center region 40 of one the side-view mirrors 26 of the vision component 16, wherein a field of focus 22 of the gaze vector 21 of the user is determined by the processor 14 to be within the center region 40 of the side-view mirror 26. Accordingly, a configuration of the side-view mirror 26 is not modified.

As shown in FIG. 4, the user is gazing toward a pre-defined outer region 42 of one the side-view mirrors 26 of the vision component 16, wherein the field of focus 22 of the gaze vector 21 of the user is determined by the processor 14 to be within the outer region 42 of the side-view mirror 26. Accordingly, the controller 28 is caused to modify a configuration of the side-view mirror 26 in an outward direction relative to the vehicle 11. As a non-limiting example, the side-view mirror 26 is configured such that a portion of the image in the outer region 42 is presented at or near a center point of the side-view mirror 26 once the side-view mirror 26 has been reconfigured.

As shown in FIG. 5, the user is gazing toward a pre-defined inner region 44 of one the side-view mirrors 26 of the vision component 16, wherein the field of focus 22 of the gaze vector 21 of the user is determined by the processor 14 to be within the inner region 44 of the side-view mirror 26. Accordingly, the controller 28 is caused to modify a configuration of the side-view mirror 26 in an inner direction relative to the vehicle 11. As a non-limiting example, the side-view mirror 26 is configured such that a portion of the image in the inner region 44 is presented at or near a center point of the side-view mirror 26 once the side-view mirror 26 has been reconfigured.

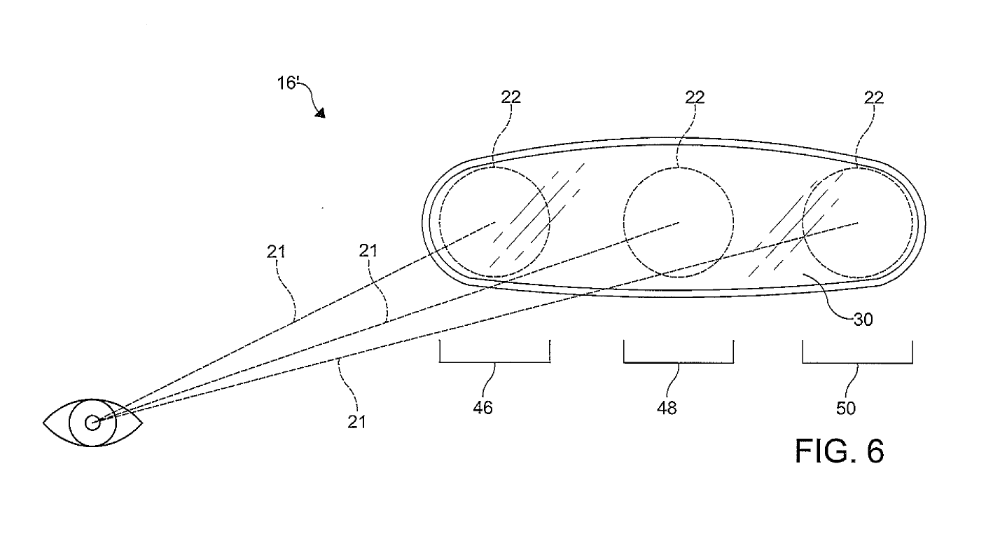

Another example of a personalized configuration is shown in FIG. 6. As shown, a vision characteristic (e.g. the gaze vector 21) of the user is monitored by the sensor(s) 12. Where the field of focus 22 of the gaze vector 21 of the user is determined to be within a pre-defined region 46, 48, 50 of the rear-view mirror 30 of the vision component 16′, the processor 14 transmits a signal to the controller 32 to modify a configuration of the rear-view mirror 30 in response to the vision characteristic that has been sensed.

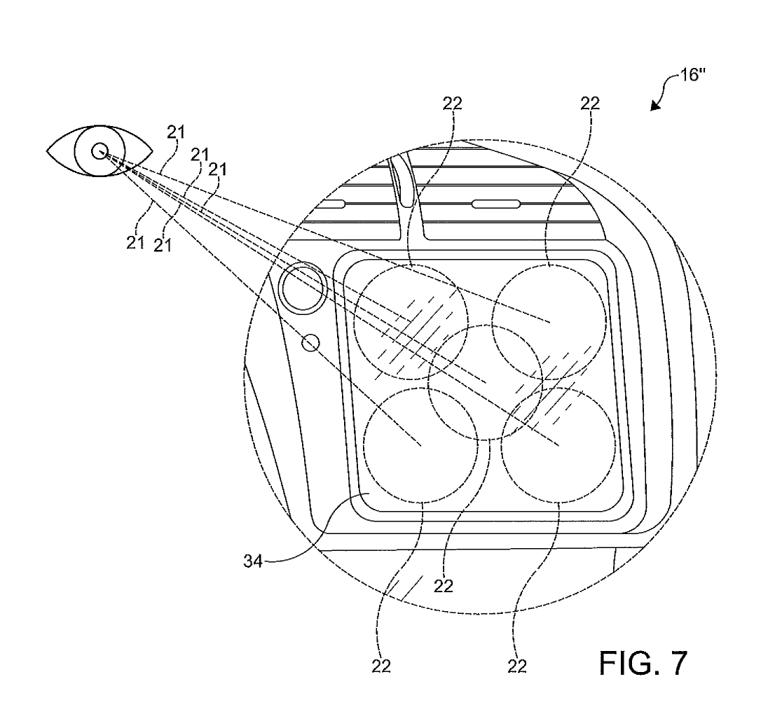

Another example of a personalized configuration is shown in FIG. 7. As shown, a vision characteristic (e.g. the gaze vector 21) of the user is monitored by the sensor(s) 12. Where the field of focus 22 of the gaze vector 21 of the user is determined to be within a pre-defined region (not shown) of the display 34 of the vision component 16″, the processor 14 transmits a signal to the controller 38 to modify a configuration of the camera 36 in response to the vision characteristic that has been sensed.

It is understood that any number of regions can be pre-defined on any number of the vision components 16, 16′, 16″ to modify an image presented to the user based upon a vision characteristic of the user.

The vision system 10 and methods of configuring the vision system 10 provide a real-time personalization of the vision components 16, 16′, 16″ and the images conveyed to the user by the vision components 16, 16′, 16″ based upon the vision characteristics of the user. Accordingly, where the user looks at a boundary of an image presented to the user by the vision system 10, the vision system 10 automatically modifies the image presented to the user, thereby maximizing a viewable coverage area of the vision components 16, 16′, 16″ without the requirement manual manipulation.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An adaptive vision system comprising:
a vision component to present an image to a user;
a sensor for detecting a vision characteristic of the user and generating a sensor signal representing the vision characteristic of the user; and
a processor in communication with the sensor and the vision component, wherein the processor receives the sensor signal, analyzes the sensor signal based upon an instruction set to determine the vision characteristic of the user, and configures the visual component based upon the vision characteristic of the user to modify the image presented to the user.

2. The vision system according to claim 1, wherein the vision component further includes a side-view mirror.

3. The vision system according to claim 1, wherein the vision component further includes a rear-view mirror.

4. The vision system according to claim 1, wherein the vision component further includes a display and a camera, the display in signal communication with the camera to present an image captured by the camera.

5. The vision system according to claim 1, wherein the vision component further includes a controller in signal communication with the processor to receive a control signal from the processor to configure the vision component based on the control signal.

6. The vision system according to claim 1, wherein the sensor is a tracking device for capturing an image of the user.

7. The vision system according to claim 1, wherein the instruction set is a software for determining at least one of a head pose of the user, a gaze direction of the user, and a field of focus of the user.

8. The vision system according to claim 1, further comprising a source of electromagnetic radiation to illuminate a portion of the user to facilitate the detecting of the vision characteristic of the user.

9. An adaptive vision system for a vehicle comprising:
a vision component configured to present an image to a user;
a controller in mechanical communication with the vision component to modify a configuration of the vision component;
a sensor for detecting a vision characteristic of the user and generating a sensor signal representing the vision characteristic of the user; and
a processor in communication with the sensor and the controller, wherein the processor receives the sensor signal, analyzes the sensor signal based upon an instruction set to determine the vision characteristic of the user, and transmits a control signal to the controller to modify the configuration of the visual component based upon the vision characteristic of the user and thereby modify the image presented to the user.

10. The vision system according to claim 9, wherein the vision component further includes a side-view mirror.

11. The vision system according to claim 9, wherein the vision component further includes a rear-view mirror.

12. The vision system according to claim 9, wherein the vision component further includes a display and a camera, the display in signal communication with the camera to present an image captured by the camera.

13. The vision system according to claim 9, wherein the sensor is a tracking device for capturing an image of the user.

14. The vision system according to claim 9, wherein the instruction set is a software for determining at least one of a head pose of the user, a gaze direction of the user, and an field of focus of the user.

15. A method of configuring a vision component, the method comprising the steps of:
providing the vision component configured to present an image to a user;
providing a sensor to detect a vision characteristic of a user; and
configuring the vision component based upon the vision characteristic of the user to modify the image presented to the user.

16. The method according to claim 15, wherein the vision component further includes a side-view mirror.

17. The method according to claim 15, wherein the vision component further includes a rear-view mirror.

18. The method according to claim 15, wherein the vision component further includes a display and a camera, the display in signal communication with the camera to present an image captured by the camera.

19. The method according to claim 15, wherein the sensor is a tracking device for capturing an image of the user.

20. The method according to claim 15, wherein the instruction set is a software for determining at least one of a head pose of the user, a gaze direction of the user, and an field of focus of the user.
